(19) United States
(12) Patent Application Publication
(10) Pub. No.: US 2008/0147881 A1
(43) Pub. Date: Jun. 19, 2008

(54) SYSTEM AND METHOD FOR PLACING COMPUTATION INSIDE A NETWORK

(76) Inventors: Rajaram B. Krishnamurthy, Poughkeepsie, NY (US); Mircea Gusat, Langnau (CH); Craig Bruab Stunkel, Bethel, CT (US); Wolfgang Emil Denzel, Langnau am Albis (CH); Peter Anthony Walker, Cedar Park, TX (US)

Correspondence Address: IBM CORPORATION, T.J. WATSON RESEARCH CENTER, P.O. BOX 218, YORKTOWN HEIGHTS, NY, 10598, US

(21) Appl. No.: 11/612,529

(22) Filed: Dec. 19, 2006

(51) Int. Cl. G06F 15/16

(52) U.S. Cl. 709/238

(57) ABSTRACT

A system and method for generating a computation graph corresponding to a communication graph and a network topology graph for a communication network interconnected using switch-elements is provided. Computation is placed in switch-elements of the computation graph. The method includes determining one or more operator-switch-elements for a computation level of the computation graph corresponding to one or more preceding-computation-level operand elements using span vector representation of the network topology graph. The method further includes selecting a last-computation-level operator-switch-element corresponding to a root-compute-node. The method allows computation to be placed inside a network to meet resource availability constraints.

### FIELD OF THE PRESENT INVENTION

The present invention generally relates to interconnection networks or switching and routing systems that connect compute or processing nodes, using a plurality of switch or router elements. More specifically, the present invention relates to a system and method for placing computation inside a network.

### BACKGROUND OF THE PRESENT INVENTION

Interconnection networks connect a plurality of compute nodes or processing nodes using switch-elements or router-elements. In a distributed computation, each compute node may perform the same or different computation. They communicate with each other when needed to share and exchange data. Data is segmented into packets and transmitted through one or more switch-elements until data reaches a destination compute node, in case the interconnection network uses switch-elements. In case of router-elements, a router element provides end-to-end optimized routing of packets and transmits packets through its internal switching fabric to the destination compute node. A single piece of data may be received by a plurality of recipients. As technology has advanced, hardware component density, Very Large Scale Integration (VLSI) transistor density, and component software engineering capabilities has increased. This allows switch-elements to be built for communication and extended for use in computation. This enables highly complex and powerful applications to be built that harness the capability of the compute node and the computation power of the network. For applications that are sensitive to compute node loading conditions and overall latency, offloading from the compute node is expected to be beneficial.

To realize this, a Network Interface Card (NIC) as disclosed in “Scalable NIC-based Reduction on Large-scale Clusters”, Supercomputing, 2003 ACM/IEEE Conference, Volume, Issue, 15-21 Nov. 2003, is placed inside a compute node and connects a compute node to the network. Large scale parallel and distributed applications spend more than half their time in reduction operations. A reduction operations performs one or more of sum, min, max, AND, and OR operation on the compute nodes of a group and deliver the result to a root node or broadcast the results to each compute node of the group. In this paper, the reduction operations are moved from the processor of a compute node to the NIC placed inside the compute-node for lower-latency and consistency.

Further, active networks are discussed in prior-art. An Active network allows computation to be placed directly inside the switch-element or a router-element of a network. This enables distribution of more complex computation across the compute nodes and the network. In active networks, computation can be executed without the involvement of the processor of the compute node. Therefore, computations can be executed with low-latency and can be independent of the loading conditions of processor of compute nodes.

To place a computation inside a switch-element or a router-element hardware and software support is required. An infrastructure for a switch-element or router-element as disclosed in “Towards an Active Network Architecture”, ACM SIGCOMM Computer Communication Review, Volume 26, Issue 2 (April 1996) can be used to “program” a network for placing computations. Compute node applications may use barrier units as described in “A Reliable Hardware Barrier Synchronization Scheme”, Parallel Processing Symposium, 1997. Proceedings, 11th International, 1-5 Apr. 1997. These are implemented inside the switch-element of an interconnection network. Compute node applications synchronize at a barrier before the next phase of a computation begins, which is a fundamental operation in most parallel and distributed computing applications. A barrier operation is simply a reduction AND computation which provides a result only when each operand provide their values to the AND function. In these approaches, each switch-element or router-element in an active network has to be activated with computation to process packets that are in-transit through the active network, irrespective of the fact that an application only requires a predefined number of switch elements to be activated for computation to achieve the same results. This is because the communication patterns of the original (non-active) application are not recorded and analyzed. This may lead to increased cost, increased power consumption and latency. In these approaches, resource availability constraints like number of active switch elements, available memory in each active switch element, communication and computation load on the active switch element and their associated cost and power are not taken into consideration. Further, they do not trade latency for reduced resource usage when possible. In some systems, distributed compute applications that use non-active networks, compute nodes are deactivated; applications of a compute node may be moved to another compute node, thereby restructuring the communication patterns of a distributed compute application for reduced cost, latency, power and improved reliability.

However, one or more of the above listed prior-arts increase cost, power, and latency in a network. Additionally, they do not provide means to restructure the distributed computation inside an active network to meet cost, latency, power and reliability needs. Further, one or more of the above listed prior-arts do not provide means to restructure an active computation network using switch-elements to balance load. Also, a reduction computation in prior-art cannot be restructured to trade latency for lower cost, to balance load, and to manage network computation memory more efficiently.

### SUMMARY OF THE PRESENT INVENTION

An object of the present invention is to provide a method and system for placing computation in a communication network interconnected with plurality of switch-elements to meet resource constraints.

Another object of the present invention is to provide a method to limit the number of computations placed in switch-elements of the communication network.

Another object of the present invention is to provide a method and system for placing computation in switch-elements of the communication network based on compile-time and run-time communication behavior of compute nodes in the communication network.

Another object of the present invention is to provide a method to restructure a reduction computation distributed across switch elements to trade latency for lower switch element reduction state. Restructuring reduction computation also balances computation and communication load across switch-elements participating in a distributed computation.

The above listed objectives are achieved by providing a method and system of generating a computation graph corresponding to a communication graph and a network topology graph for a communication network interconnected using switch-elements. The method includes determining one or more operator-switch-elements for a computation level of the computation graph corresponding to one or more preceding-computation-level operand elements using span vector representation of the network topology graph. The network topology graph includes a plurality of switch-elements and a plurality of compute nodes. An operand element is one of a switch-element and a compute node. One or more operator-switch-elements are determined based on a link-cost-function of one or more operator-switch-elements corresponding to one or more preceding-computation-level operand elements. An operator-switch-element receives operand values from one or more preceding-computation-level operand elements. The method further includes selecting a last-computation-level operator-switch-element corresponding to a root-compute-node. The last-computation-level operator-switch-element is selected based on a least aggregate-link-cost-function. An aggregate-link-cost-function corresponds to sum of minimum link-cost-function corresponding to one or more preceding-computation-level operand elements and a root-link-cost-function. The root-link-cost-function is a link-cost-function of a last-computation-level operator-switch-element corresponding to the root-compute-node. The root-compute-node receives an output of the computation graph corresponding to the last-computation-level operator-switch-element.

In an embodiment of present invention, the above listed objectives are achieved by providing a method and system of placing computation in a communication network using a plurality Switch Offload Engines (SOE). An SOE is a device attached to a switch-element and is capable of performing computations. An SOE may be externally attached to a switch-element, for example, an SOE may be attached to switch-element ports. An SOE may be a chip embedded inside a switch-element port card or line-card. In yet another exemplary embodiment, the SOE can be a function inside a line-card or port-card packet processor. The communication network is interconnected using switch-elements. The method includes providing a communication graph of the computation. The method further includes extracting a network topology graph of the communication network. The network topology graph is represented using span vectors. Thereafter, a computation graph is generated corresponding to the communication graph and the network topology graph.

The system includes a span-vector-list module, and a mapper module to perform the above listed method steps.

### BRIEF DESCRIPTION OF THE DRAWINGS

The foregoing objects and advantages of the present invention for placing computation inside a communication network may be more readily understood by one skilled in the art with reference being had to the following detailed description of several preferred embodiments thereof, taken in conjunction with the accompanying drawings wherein like elements are designated by identical reference numerals throughout the several views, and in which:

FIG. 1 is a block diagram showing a communication graph in which various embodiments of the invention may function.

FIG. 2 is a block diagram showing a network topology graph in which various embodiments of the invention may function.

FIG. 3 is a flow diagram of a method for generating a computation graph corresponding to a communication graph and a network topology graph for a communication network interconnected using switch-elements, in accordance with an embodiment of the present invention.

FIGS. 4A and 4B depicts a flow diagram of a method for generating a computation graph corresponding to a communication graph and a network topology graph for a communication network interconnected using switch-elements, in accordance with an embodiment of the present invention.

FIG. 5 is a block diagram showing a computation graph (that is exemplary) generated from a communication graph and a network topology graph, in accordance with an embodiment of the present invention

FIG. 6 is a flow diagram of a method of placing computation in a communication network using a plurality Switch Offload Engines (SOE), in accordance with an embodiment of the present invention.

FIG. 7 is a block diagram showing a system for placing computation in a communication network by generating a computation graph corresponding to a communication graph and a network topology graph for the communication network using a plurality SOEs, in accordance with an embodiment of the present invention.

FIG. 8 is a block diagram showing modules of a mapper module, in accordance with an embodiment of the present invention.

FIG. 9 is a block diagram showing modules of a reduction-graph conversion module, in accordance with an embodiment of the present invention.

### DETAILED DESCRIPTION OF THE DRAWINGS

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art.

Various embodiments of the present invention provide methods and systems for placing computation inside a communication network. The communication network is interconnected using a plurality of switch-elements. The computations are placed inside one or more switch-elements in Switch Offload Engines (SOE). An SOE is a device attached to a switch-element and is capable of performing computations. In an exemplary embodiment, the SOE can consist of a processor, Field-Programmable Gate Array (FPGA), and memory. An SOE may be externally attached to a switch-element, for example, an SOE may be attached to switch-element ports. In an exemplary embodiment, the SOE is dual-ported and has one port attached to an input port of the switch. The second port of the SOE is attached to an output port of the switch. In another exemplary embodiment, the SOE is attached to “slow” ports or management ports of the switch. In this manner, none of the data ports of the switch element need be used to attach an SOE. In another exemplary embodiment, an SOE may be a chip embedded inside a switch-element port card or line-card. In yet another exemplary embodiment, the SOE can be a function inside a switch-element line-card or port-card packet processor. The switch-elements that have SOEs activated or coupled to it may perform computation on values passed on by a plurality of compute nodes in the communication network.

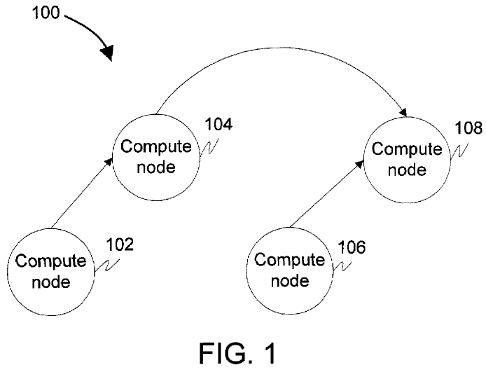

FIG. 1 is a block diagram showing a communication graph 100 (that is exemplary) in which various embodiment of the invention may function. Communication graph 100 includes a compute node 102, a compute node 104, a compute node 106, and a compute node 108. Communication graph 100 represents the communication between each of compute node 102, compute node 104, compute node 106, and compute node 108. Compute node 102 is a child node for compute node 104, which is a parent node for compute node 102. Compute node 104 and compute node 106 are child nodes of compute node 108, which is a parent node for each of compute node 104 and compute node 106. Compute node 108 is a root node of communication graph 100. A result of the computation performed in communication graph 100 is stored in compute node 108. Communication graph 100 is used to find by reduction a global maximum of values in compute node 102, compute node 104, compute node 106 and compute node 108. The result is stored in the root node, i.e., compute node 108.

Compute node 102 transmits a first value to compute node 104 and is therefore reduced with compute note 104. Compute node 102 is an operand element for compute node 104, which is an operator element for compute node 102. Compute node 104 then performs a first computation on the first value received from compute node 102. It will be apparent to a person skilled in the art that compute node 104 may perform more than one computation on the first value. For example, the first value transmitted from compute node 102 to compute node 104 is five. Thereafter, compute node 104 performs the first computation and compares the first value with a second value stored in compute node 104 to determine greater of the two values. In this example, the second value is seven. Therefore, compute node 104 determines the second value as the greater value.

Similarly, compute node 106 transmits a third value to compute node 108 and is therefore reduced with compute node 108. Compute node 106 is an operand element for compute node 108, which is an operator element for compute node 106. Compute node 108 then performs a second computation on the third value. It will be apparent to a person skilled in the art that compute node 108 may perform more than one computation on the third value. For example, the third value transmitted from compute node 106 to compute node 108 is four. Compute node 108 stores the value two. Compute node 108 performs the second computation and determines four (value of compute node 106) as the greater value.

After reducing each of compute node 102 and compute node 106 with a corresponding compute node, compute node 104 is reduced with compute node 108. Compute node 104 sends a value determined after performing the first computation to compute node 108, which performs a third computation on the value to determine the result of computations performed in communication graph 100. Compute node 104 is an operand element for compute node 108, which is an operator element for compute node 104. For example, the value seven determined after performing the first computation at compute node 104 is transmitted to compute node 108. Compute node 108 performs the third computation on the value seven and compares the value seven with the value four, which is determined after performing the second computation at compute node 108, to determine greater of the two. Compute node 108 determines the value seven as the greater of the two. The value seven is therefore the global maximum reduction result of computations performed in communication graph 100.

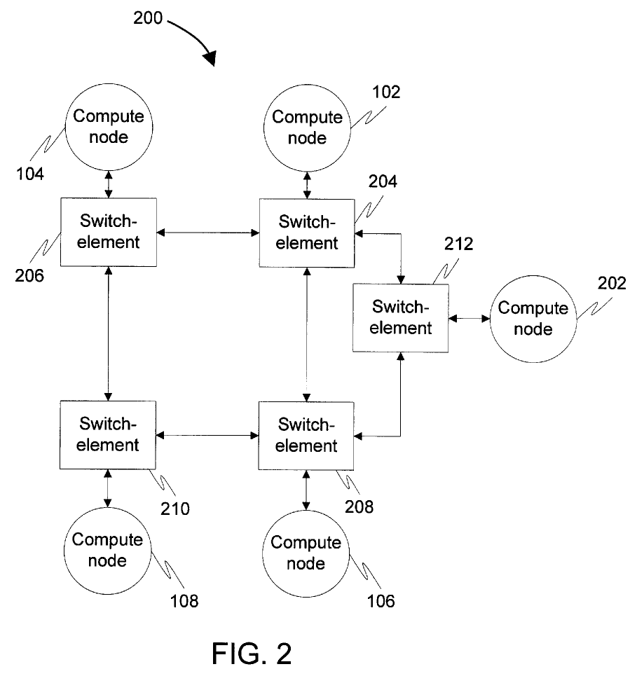

FIG. 2 is a block diagram showing a network topology graph 200 (that is exemplary) in which various embodiments of the invention may function. Network topology graph 200 includes compute node 102, compute node 104, compute node 106, and compute node 108 of communication graph 100 as depicted in FIG. 1 and compute node 202. Additionally, network topology graph 200 includes a switch-element 204, a switch-element 206, a switch-element 208, a switch-element 210, and a switch-element 212. Network topology graph 200 represents interconnections of each switch-element and each compute node with other switch-elements and compute nodes.

The interaction of each switch-element with one or more compute nodes and/or one or more switch-elements in the network topology graph 100 is represented by span vectors. The span vectors represent each switch-element in form of a tuple. A tuple can include information pertaining to a switch-element name, number of ports of a switch-element, a compute node or a switch-element on each port, and a function of least hop-count distance to each compute node and each switch-element, relative to the switch-element. An address of a switch element is a distinct integer value assigned to each switch-element. For example, span vectors represent switch-element 206 in the form of a tuple. The tuple for switch-element 206 is represented as address of switch-element 206, number of ports of switch-element 206, address of a compute node or a switch-element on each port and a least hop-count distance to each switch-element and compute node in network topology graph 200. Therefore, the tuple of switch-element 206 may be represented as [(address of switch-element 206), (number of ports, i.e., three), (address of compute node 104 coupled to a first port, address of switch-element 204 coupled to a second port, address of switch-element 210 coupled to a third port), (shortest hop-count distance of each compute node and each switch-element, i.e., compute node 104 (1), compute node 102 (2), compute node 106 (3), compute node 108 (2), compute node 202 (3), switch-element 204 (1), switch-element 208 (2), switch-element 210 (1), switch-element 212 (2))].

Compute node 102 transmits one or more values to switch-element 204, which is one hop-count distance from compute node 102. Therefore, compute node 102 is an operand element for switch-element 204 and one or more values are operand values. Switch-element 204 then performs one or more computations on one or more operand values. Therefore, switch-element 204 is an operator-switch-element for compute node 102. Similarly, compute node 104 is an operand element for switch-element 206, which is an operator-switch-element for compute node 104 and is one hop-count distance from compute node 104. Compute node 104 transmits one or more operand values to switch-element 206. Switch-element 206 then performs one or more computations on one or more operand values. Referring back to FIG. 1, if compute node 104 and compute node 102 use switch-element 206 for computation, then switch-element 206 is said to be at the first computation level. Similarly, if compute node 106 and compute node 108 choose to use switch element 210 for computation, then correlating with FIG. 1, switch-element 210 is also at the same first computation level as switch-element 206. This is because in FIG. 1, compute node 102 and compute node 104 interact with each other as the first computation level. Similarly, compute node 106 and compute node 108 interact with each other, also as the first level of the computation. The result from compute node 104 and compute node 108 undergo one or more computations in compute node 108 as the second (next) level of computation.

In FIG. 2, switch-element 206 performs the computation for compute node 104 and compute node 102. Switch element 210 performs the computation for compute node 106 and compute node 108. Switch-element 206 forwards its result to switch-element 210. Switch-element 210 uses the result from the first computation level operation (of compute node 106 and compute node 108) and the result from switch-element 206. This operation is said to be performed at the second computation level. The resultant value is sent back to compute node 108, which functions as the root node. Switch-element 206 and switch-element 210 are said to be at the penultimate-computation-level. Switch element 210 is said to be again used for the last-computation-level. The collection of compute node 104, compute node 102, compute node 106 and compute node 108, switch-element 206, and switch-element 210 along with connecting links is said to compose a computation graph.

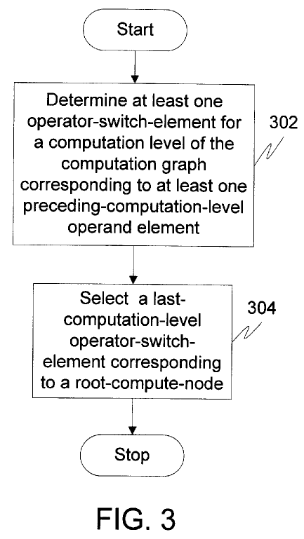

FIG. 3 is a flow diagram of a method for generating a computation graph corresponding to a communication graph and a network topology graph for a communication network interconnected using switch-elements, in accordance with an embodiment of the present invention. The computation graph is generated by mapping a communication graph to a network topology graph. The communication graph is provided by a programmer of the communication and computer network. In an embodiment of the present invention, the communication graph is provided by dynamic profiling programs. A dynamic profiling program records and generates the communication pattern of the compute nodes. A dynamic profiling program, for example may be XMPI. It will be apparent to people skilled in the art that in a communication graph one or more compute nodes may interact with one or more switch-elements and compute nodes. Similarly, one or more switch-elements may interact with one or more compute nodes and switch-elements.

To generate the computation graph of the communication network, one or more operator-switch-elements are determined for a computation level of the computation graph at step 302. One or more operator-switch-elements are determined corresponding to one or more preceding-computation-level operand elements using span vector representation of the network topology graph. An operator-switch-element receives operand values from one or more preceding-computation-level operand elements. An operand element is one of a switch-element and a compute node. This has been explained in conjunction with FIG. 2.

One or more operator-switch-elements are determined for the computation level based on a link-cost-function of one or more operator-switch-elements corresponding to one or more preceding-computation-level operand elements. A link-cost-function of an operator-switch-element is function of its hop-count distance from the one or more preceding-computation-level operand elements. The hop-count distance between two elements on a graph is the shortest distance between those two elements on the graph.

In an embodiment of the present invention, the link-cost-function of an operator-switch-element is an average hop-count distance of each preceding-computation-level operand element relative to the operator-switch-element on the network topology graph. For example, the first link-cost-function for switch-element 208 corresponding to preceding-computation-level operand element, i.e., switch-element 206 and switch-element 204 is represented as [(Hop-count distance of switch-element 206 relative to switch-element 208)+(Hop-count distance of switch-element 204 relative to switch-element 208)]/2. Therefore, the link-cost-function for the switch-element 208 is equal to one and a half.

In another embodiment of the present invention, the link-cost-function of an operator-switch-element is the sum of hop-count distance of each preceding-computation-level operand element relative to the operator-switch-element on the network topology graph. This enables capturing worst-case loading conditions on the network links. For example, the first link-cost-function for switch-element 208 corresponding to switch-element 206 and switch-element 204 is represented as [(Hop-count distance of switch-element 206 relative to switch-element 208)+(Hop-count distance of switch-element 204 relative to switch-element 208)]. Therefore, the link-cost-function for the switch-element 208 is equal to three.

In another embodiment of the present invention, the link-cost-function of an operator-switch-element is maximum hop-count distance of one or more preceding-computation-level operand elements relative to the operator-switch-element on the network topology graph. This enables detecting links in networks through which data is always sent from switch-elements at the same time step. For example, the first link-cost-function for switch-element 208 is represented as MAX [(Hop-count distance of switch-element 206 relative to switch-element 208), (Hop-count distance of switch-element 204 relative to switch-element 208)]. Therefore, the link-cost-function for the switch-element 208 is equal to two.

In another embodiment of the present invention, the link-cost-function of an operator-switch-element is the weighted average of the hop-count distance of each preceding-computation-level operand element relative to the operator-switch-element on the network topology graph. In an exemplary embodiment of the present invention, the weights are assigned based on the bandwidth available at an operator-switch-element to handle load. This enables capturing link properties for networks with links of varying bandwidth, congestion and loading conditions. For example, if switch-element 208 is coupled to switch-element 206 through a port supporting two lane communication and to switch-element 204 through a four lane communication. Therefore, the first link-cost-function for switch-element 208 is represented as [(Hop-count distance of switch-element 206 relative to switch-element 208)/2, (Hop-count distance of switch-element 204 relative to switch-element 208)/4]/(1/2+1/4). Therefore, the link-cost-function for the switch-element 208 is equal to 1.67.

One or more operator-switch-elements that have minimum link-cost-function are determined for the computation level. For example, referring to FIG. 2, the values in compute node 102 and compute node 104 need to be reduced. An operator-switch-element is required to be determined for the compute node 104 and compute node 102, which are the operand elements. The computation can be executed on one or more of switch-element 204, switch-element 206, switch-element 208, switch-element 210, and switch-element 212 based on a link-cost-function relative to compute node 104 and compute node 102.

Switch-element 204 is one hop-count distance from compute node 102 and two hop-count distance from compute node 104. Therefore, link-cost-function of switch-element 204 is represented as [(hop-count distance of switch-element 204 relative to compute node 102, i.e., one)+(hop-count distance of switch-element 204 relative to compute node 104, i.e., two)]. Therefore, link-cost-function of switch-element 204 is three with respect to compute node 104 and compute node 102.

Similarly, hop-count distance of switch-element 206 relative to compute node 102 is two and hop-count distance of switch-element 206 relative to compute node 104 is one. Therefore, link-cost-function of switch-element 206 is three. Similarly, hop-count distance of switch-element 208 relative to compute node 102 is two and hop-count distance of switch-element 208 relative to compute node 104 is three. Therefore, link-cost-function of switch-element 208 is five. Further, hop-count distance of switch-element 210 relative to compute node 102 is three and hop-count distance of switch-element 210 relative to compute node 104 is two. Therefore, link-cost-function of switch-element 210 is five. Similarly, hop-count distance of switch-element 212 relative to compute node 102 is two and hop-count distance of switch-element 212 relative to compute node 104 is three. Therefore, link-cost-function of switch-element 212 is five.

Based on the link-cost-functions calculated above, each of switch-element 204 and switch-element 206 has a link-cost-function of three, which is minimum, relative to compute node 102 and 104. Therefore, two operator-switch-elements, i.e., switch-element 204 and switch-element 206 exist for the computation level. In other words, either could perform the computation for compute node 104 and compute node 102.

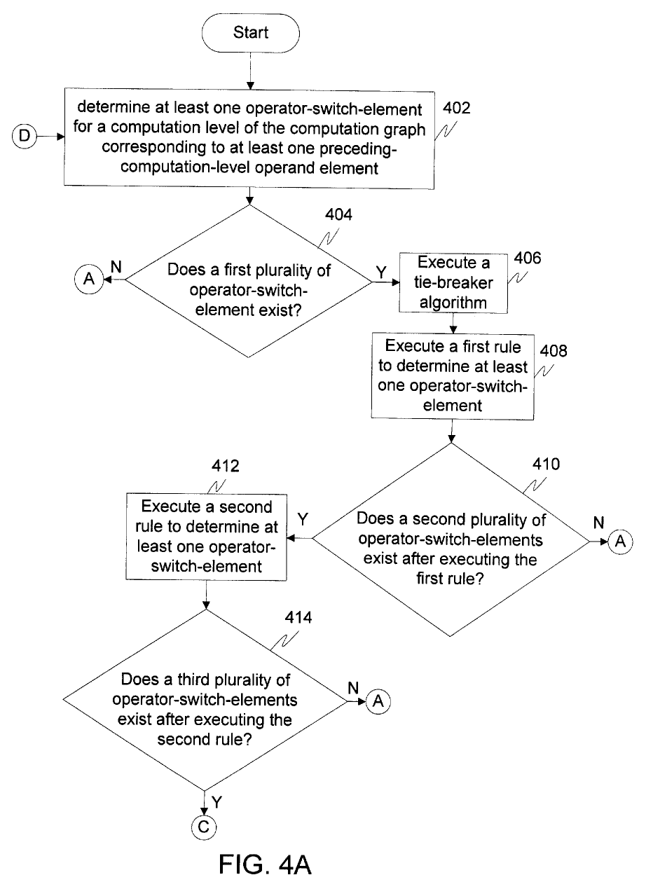

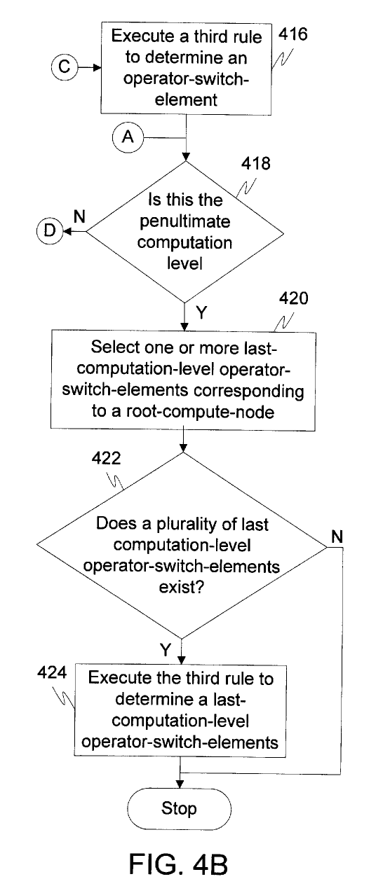

While determining one or more operator-switch-elements for the computation level, if a first plurality of operator-switch-elements that have a least link-cost-function exist for the computation level, then a tie-breaker algorithm is executed. The tie-breaker algorithm determines an operator-switch-element for the computation level corresponding to one or more preceding-computation-level operand element. The tie-breaker algorithm includes a plurality of rules. For example, three switch-elements for a computation level have least link-cost-function. Therefore, the tie-breaker is executed to determine an operator-switch-element for the computation level from three switch-elements. The tie-breaker algorithm executes a first rule to determine one or more operator-switch-elements. This is explained in detail in conjunction with FIG. 4A and FIG. 4B.

After determining one or more operator-switch-elements for different computation levels and upon reaching the last computation level, a last-computation-level operator-switch-element is selected corresponding to a root-compute-node, at step 304. A root-compute-node is a node that receives an output of the computation graph corresponding to the last-computation-level operator-switch-element. The last-computation-level operator-switch-element performs computations on one or more operand values received from one or more preceding-computation-level operand elements.

The last-computation-level operator-switch-element is selected based on a least aggregate-link-cost-function. An aggregate-link-cost-function corresponds to sum of minimum link-cost-function corresponding to one or more preceding-computation-level operand elements and a root-link-cost-function. A root-link-cost-function is a link-cost-function of a last-computation-level operator-switch-element corresponding to the root-compute-node. This is explained in detail in conjunction with FIGS. 4A & 4B. The compute nodes, switch elements and links form a computation graph.

In order that all the compute nodes and switch-elements in the computation graph that has been so determined can participate in the distributed computation, the SOE in each switch-element needs to be enabled. In one embodiment of the present invention, it can be physically attached to the switch-element and loaded with input operand processing instructions in computation-table-entries. In another embodiment of the present invention, it is activated or “turned-on” remotely with input operand processing instructions in computation-table-entries. Communication pattern based placement of SOEs ensures that they are placed only in required switch-elements. Further, remote activation of SOEs ensures that only SOEs participating in a distributed computation need be attached or activated. This saves cost, power and latency over attaching and activating SOEs on each switch-element.

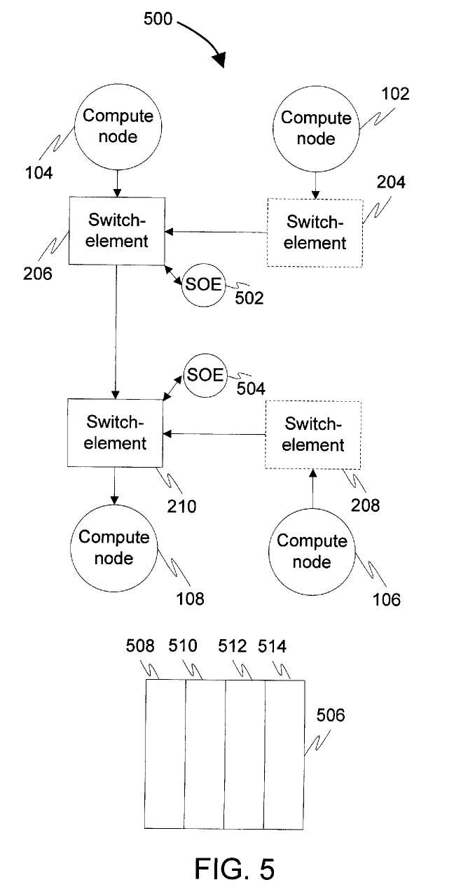

Each SOE includes one or more computation table entries. A computation-table-entry of an SOE records one or more of inputs, formats and datatypes, functions, and outputs of a switch-element to which the SOE is attached. The SOE is explained in detail in conjunction with FIG. 5. An SOE uses the computation-table-entry to redirect values from input ports of a switch-element it needs to read and process. On receipt of these values inside the SOE, it processes the data using the function provided in the computation-table-entry. The output of this function evaluation is then redirected to the output port of the switch.

The computation graph may be a reduction-computation-graph. In the reduction-computation-graph, each operator-switch-element for each computation level has preceding-computation-level operand elements. Each operator-switch-element is a parent node and the corresponding preceding-computation-level operand elements are child nodes. For example, switch-element 208 is a parent node and the corresponding preceding-computation-level operand elements, i.e., switch-element 206 and switch-element 204 are child nodes. Similarly, switch-element 210 is a parent node and the corresponding preceding-computation-level operand elements, i.e., switch-element 208, and switch-element 212 are child nodes. A parent node receives operand values from the corresponding child nodes. Thereafter, the parent node performs computations on the operand values.

In an embodiment of the present invention, a pass-through reduction table entry is made in a switch-element in the computation-table-entry of the SOE. This in turn sets the line-card or port-card of a switch element to pass computation values to the required output port directly. A pass-through reduction table entry corresponds to passing operand values of each child node of the switch-element to a succeeding parent node by the switch-element. The succeeding parent node is a parent of the switch-element. For example, assume switch-element 210 is picked to reduce values for compute node 104 and compute node 102 in FIG. 5. This would require a pass-through entry in switch element 204 and a pass-through entry in switch element 206. Switch element 210 would perform the computation. Compute node 102 and compute node 104 would be child nodes of switch-element 210. Switch element 210 would serve as the parent node. This is further explained in detail in conjunction with FIG. 5.

A child node passing operand values to parent nodes results in a reduction computation graph, which is represented by a degree. The degree of a reduction graph is represented as, (n+1), where n is the number of child nodes of each parent node. For example, if each parent node in the computation graph has three child nodes, then the degree of the reduction computation graph is four. In an embodiment of the present invention, a degree of a reduction computation graph is increased by adding children of child nodes to a target parent node. The target parent node is parent of the child nodes. Thereafter, the reduction computation-table-entry of the target parent node is updated to process more operand values in response to adding children of the child nodes. Although now a target parent node processes more operands, fewer SOEs need to be activated. This helps trade increased latency for lower cost and power. In addition, reduction operations that are low in computational complexity (integer add versus floating point divide) can benefit from such restructuring. Adding more operands to an integer add is less likely to be affected in terms of latency than adding more operands to a floating-point operation. The degree of the reduction computation graph may be increased when the reduction computation graph does not perform a complex computation or performs more communication-oriented operations than computation-oriented operations.

In another embodiment of the present invention, the degree of a reduction computation graph is reduced by removing child nodes of a donor parent node. The child nodes are attached to one of one or more existing parent node and a new parent node. The reduction computation-table-entry of the donor parent node is updated to process less operands in response to removing the child nodes. Additionally, a reduction table entry of a recipient parent node is updated to process increased operands in response to removing the child nodes. The recipient parent node is an existing parent node and receives the child nodes of the donor parent node. If the child nodes are attached to a new parent node, then a reduction table entry of the new parent node is updated to process operands for the child nodes of the donor parent node. In an embodiment of the present invention, a child node of the donor parent node is converted into the new parent node. In another embodiment of the present invention, a new parent node may be added in the reduction computation graph. Thereafter, a new reduction table entry is made for the new parent node. This allows computation and communication load to be balanced by removing operands from a parent node. Further, computations can be realized in the network to meet resource constraints. In this case, possibly trading lower latency (from decreased operand count in a computationally complex operation) for increased cost or power (more SOEs).

FIGS. 4A and 4B depicts a flowchart of a method for generating a computation graph corresponding to a communication graph and a network topology graph for a communication network interconnected using switch-elements, in accordance with another embodiment of the present invention. At step 402, one or more operator-switch-elements are determined for a computation level of the computation graph. One or more operator-switch-elements are determined corresponding to one or more preceding-computation-level operand elements using span vector representation of the network topology graph. This has been explained in detail in conjunction with FIG. 3. At step 404, a check is performed to determine if a first plurality of operator-switch-elements exists for the computation-level. If the first plurality of operator-switch-elements are not determined for the computation-level, then at step 418, a check is performed to determine if the computation level is the penultimate computation level. If the computation level is not the penultimate computation level, then step 402 is repeated. However, if computation level is the penultimate computation level, then at step 420 one or more last-computation-level operator-switch-elements are selected corresponding to a root-compute-node. This has been explained in conjunction with FIG. 3 and FIG. 2.

Thereafter, at step 422, a check is performed to determine if a plurality of last-computation-level operator-switch-elements exist. If a plurality of last-computation-level operator-switch-elements exists, then a third rule is executed to determine a last last-computation-level operator-switch-element at step 424. The third rule determines an operator-switch-element with a least switch index or address. Each operator-switch-element is associated with a distinct switch index, which is an integer assigned randomly.

Referring back to step 404, if the first plurality of operator-switch-elements are determined for the computation-level, then at step 406, the tie-breaker algorithm is executed to determine an operator-switch-element for the computation level corresponding to one or more preceding-computation-level operand elements, if the first plurality of operator-switch-elements are determined for the computation-level. The tie-breaker algorithm includes a plurality of rules.

Thereafter, at step 408, the tie-breaker algorithm executes a first rule. The first rule determines one or more operator-switch-elements from a combination-tuple-set of switch-elements. The combination-tuple-set of switch-elements have least proximity link-cost-function. A tuple of a combination-tuple-set is a combination of operator-switch-elements. The operator-switch-element function as operand-switch-elements for a succeeding level in the computation graph. A proximity link-cost-function is an aggregate-link-cost-function of switch-elements in a tuple of the combination-tuple-set corresponding to a least common ancestor in the computation graph. Referring back to the example in FIG. 2 with communication graph in FIG. 1, each of switch-element 204 and switch-element 206 has a link-cost-function of three, which is minimum, relative to compute node 102 and 104. Therefore, two operator-switch-elements, i.e., switch-element 204 and switch-element 206 exist for the computation level. In an embodiment of the present invention, switch-element 204 and switch-element 206 form a tuple for the computation level.

Further, a switch-element that computes values for compute node 108 and compute node 106 is required to be determined. The computations can be executed on one or more of switch-element 204, switch-element 206, switch-element 210, switch-element 210, and switch-element 212 based on a link-cost-function relative to each of compute node 106 and compute node 108, which act as preceding-computation-level operand element. Switch-element 208 is not enabled to perform computations in this example. Based on the method given in example of FIG. 3, link-cost-function of switch-element 210 is minimum, i.e., three. Therefore, one operator-switch-element, i.e., switch-element 210 exists for the computation level.

As switch-element 204 and switch-element 206 exists for the computation level relative to compute node 102 and compute node 104 and switch-element 210 exist for the computation level relative to compute node 106 and compute node 108. Therefore, the combination-tuple-set for the computation level is represented as [(switch-element 204, switch-element 210), (switch-element 206, switch-element 210)], where (switch-element 204, switch-element 210) is a first combination-tuple and (switch-element 206, switch-element 210) is the second combination-tuple for the computation level.

The least common ancestor of switch-element 204 and switch-element 210 is switch-element 206 at a hop-distance of two (1+1). The least common ancestor of switch-element 206 and switch-element 210 is switch-element 210 or switch-element 206 at a hop-count distance of 1 (1+0). Therefore, the proximity-link-cost-function for the first combination-tuple relative to switch-element 206 (the least common ancestor) is two, i.e., one+one. Similarly, considering the second combination-tuple, the least common ancestor is chosen as switch-element 210. We pick switch-element 210 as it is closer to compute-node 108, which is the root node. For the second combination-tuple, the proximity-link-cost-function is one+zero i.e. one. Therefore, the second combination-tuple with least proximity-link-cost-function is selected. Thereafter, an SOE attached or embedded inside each of switch-element 206 and switch-element 210 is activated. Compute node 102 forwards operand values to switch-element 206 through switch-element 204. Further, compute node 104 directly forwards operand values to switch-element 206. A computation of these values is performed in switch-element 206. This result is thereafter passed on to switch-element 210. Switch-element 210 performs computations on values received from compute node 106 and compute node 108. The value from compute node 106 is passed through directly from switch-element 208 to switch-element 210. The result of this value and the value received from switch-element 206 are then computed. The result is sent back to compute node 108 as required in FIG. Thereafter, at step 410, a check is performed to determine if the first rule determines a second plurality of operator-switch-elements. If the first rule does not determine a second plurality of operator-switch-elements, then step 418 is performed. However, if the first rule determines the second plurality of operator-switch-elements, then, at step 412, the tie-breaker algorithm executes a second rule. The second rule determines one or more operator-switch-elements with least number of computation-table-entry records. A computation-table-entry records one or more of inputs, format, datatype, computation function and outputs of an operator-switch-element. This gives precedence to switch-elements that have more storage available for operand-switch-element processing instructions recorded in computation-table-entry records. Switch-elements reaching storage limits get lower priority for computation assignment. This helps balance load and manages memory more efficiently.

In an embodiment of the present invention, the second rule is executed before the first rule, if computation-table-entry record counts corresponding to one or more operator-switch-elements exceed a predefined count threshold. This enables selecting a switch-element, which has more space for computation-table-entry records over other switch-elements. This gives SOE state storage precedence over latency (proximity-link-cost-function). Thereafter, at step 414, a check is performed to determine if the second rule determines a third plurality of operator-switch-elements. If the second rule determines a third plurality of operator-switch-elements, then at step 416, the tie-breaker algorithm executes the third rule. The third rule determines an operator-switch-element with a least switch index. Each operator-switch-element is associated with a distinct switch index, which is an integer assigned randomly. Thereafter, step 418 to step 424 are performed.

FIG. 5 is a block diagram showing a computation graph 500 (that is exemplary) generated from communication graph 100 and network topology graph 200, in accordance with an embodiment of the invention. Referring back to FIG. 3 and FIGS. 4A and 4B, switch-element 206 and switch-element 210 are determined for the computation level. Therefore, an SOE 502 is coupled to switch-element 206 and an SOE 504 is coupled to switch-element 210. Compute node 102 transmits operand values to switch-element 204. Switch-element 204 passes the operand values through to switch-element 206. Compute node 104 also transmits operand values to switch-element 206. Thereafter, SOE 502 coupled to switch-element 206 performs computation on the operand values. Switch-element 206 forwards the result of the computation to switch-element 210. Switch-element 210 also receives operand values from compute node 106 through switch-element 208. Thereafter, SOE 504 coupled to switch-element 210 performs computations on received operand values. The result is then passed on to compute node 108. Each of SOE 502 and SOE 504 has a computation-table-entry 506.

Computation-table-entry 506 includes an input port list field 508, a data format and datatypes field 510, a function field 512, and an output port list field 514. An SOE sets the line-card or port-card of the switch to forward network computation packets to the SOE. The SOE waits for each input port in input port list field 508 to provide data. Arriving data is checked with data format and datatypes field 510 for format and datatype consistency. The SOE can concurrently process other computation-table-entries while waiting for data. After all ports in input port list field 508 have responded with data, function field 512 is applied to the input data received from input port list field 508. The final result is sent on ports defined in output port list field 514.

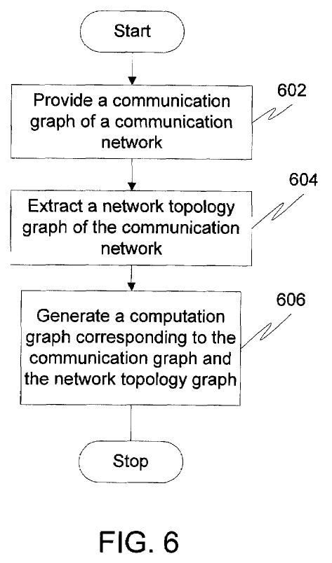

FIG. 6 is a flowchart of a method of placing computation in a communication network using a plurality of SOE. The communication network is interconnected using switch-elements. At step 602, a communication graph of the communication network is provided. In an embodiment of the present invention, the communication graph is provided by a programmer of the communication and computer network. In another embodiment of the present invention, the communication graph is provided by dynamic profiling programs. This has been explained in conjunction with FIG. 2 and FIG. 3. At step 604, a network topology graph of the communication network is extracted. The network topology graph is extracted by representing switch elements using span vectors. This has been explained in conjunction with FIG. 2 and FIG. 3.

Thereafter, at step 606, a computation graph corresponding to the communication graph and the network topology graph is generated. To generate the computation graph, one or more operator-switch-elements are determined for a computation level of the computation graph. One or more operator-switch-elements are determined corresponding to one or more preceding-computation-level operand elements using span vector representation of the network topology graph. An operator-switch-element receives operand values from one or more preceding-computation-level operand elements. An operand element is one of a switch-element and a compute node. One or more operator-switch-elements are determined for the computation level based on a link-cost-function of one or more operator-switch-elements corresponding to one or more preceding-computation-level operand elements. This has been explained in conjunction with FIG. 2 and FIG. 3.

After determining one or more operator-switch-elements, a last-computation-level operator-switch-element is selected corresponding to a root-compute-node. The root-compute-node receives an output of the computation graph corresponding to the last-computation-level operator-switch-element. This has been explained in conjunction with FIG. 2 and FIG. 3.

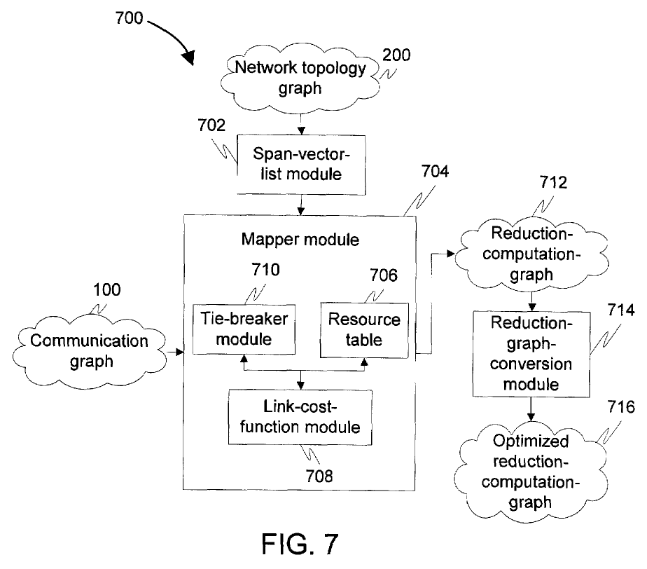

FIG. 7 is a block diagram showing a system 700 for placing computation in the communication network by generating the computation graph corresponding to the communication graph and the network topology graph for the communication network using a plurality of SOE. System 700 includes a span-vector-list module 702 and a mapper module 704. Span-vector-list module 702 receives network topology graph 200 as an input and represents a switch-element as a tuple in the network topology graph. A tuple includes one or more of a switch-element name, number of ports of a switch-element, one of a compute node and a switch-element on each port, and a shortest hop-distance to each compute node and each switch-element communicating with the switch-element. This has been explained in conjunction with FIG. 2 and FIG. 3. Additionally, one or more of computation-table-entries and table entry count for each switch-element are stored in a resource table 706 in system 700.

Thereafter, mapper module 704 receives communication graph 100 as an input and maps the communication graph to the network topology graph. Mapper module 704 is configured to determine one or more operator-switch-elements for a computation level of the computation graph. One or more operator-switch-elements are determined corresponding to one or more preceding-computation-level operand elements using span vector representation of the network topology graph. An operator-switch-element receives operand values from one or more preceding-computation-level operand elements. An operand element is one of a switch-element and a compute node. One or more operator-switch-elements are determined for the computation level based on a link-cost-function of one or more operator-switch-elements corresponding to one or more preceding-computation-level operand elements. This has been explained in detail in conjunction with FIG. 2 and FIG. 3.

A link-cost-function module 708 in system 700 determines the link-cost-function of an operator-switch-element corresponding to one or more preceding-computation-level operand elements. In an embodiment of the present invention, the link-cost-function to an operator-switch-element is an average hop-count distance of each preceding-computation-level operand element relative to the operator-switch-element on the network topology graph. In another embodiment of the present invention, the link-cost-function of an operator-switch-element is the sum of hop-count distance of each preceding-computation-level operand element relative to the operator-switch-element on the network topology graph.

In another embodiment of the present invention, the link-cost-function of an operator-switch-element is maximum hop-count distance of one or more preceding-computation-level operand elements relative to the operator-switch-element on the network topology graph. In another embodiment of the present invention, the link-cost-function of an operator-switch-element is the weighted average of the hop-count distance of each preceding-computation-level operand relative to the operator-switch-element on the network topology graph.

If mapper module 704 determines the first plurality of operator-switch-elements for the computation level using link-cost-function module 708, then a tie-breaker module 710 in mapper module 704 determines an operator-switch-element for the computation level. Tie-breaker module 710 is further explained in detail in conjunction with FIG. 7.

After determining one or more operator-switch-elements for a computation level of the computation graph, mapper module 704 selects a last-computation-level operator-switch-element corresponding to a root-compute-node. A root-compute-node is a node that receives an output of the computation graph corresponding to the last-computation-level operator-switch-element. The last-computation-level operator-switch-element performs computations on one or more operand values received from one or more preceding-computation-level operand elements. The last-computation-level operator-switch-element is selected based on a least aggregate-link-cost-function. An aggregate-link-cost-function corresponds to sum of minimum link-cost-function corresponding to one or more preceding-computation-level operand elements and a root-link-cost-function. A root-link-cost-function is a link-cost-function of a last-computation-level operator-switch-element corresponding to the root-compute-node. This has been explained in conjunction with FIG. 2. After mapper module 704 selects an operator-switch-element for each computation level and the last-computation-level operator-switch-element, an SOE is attached to them to generate computation graph 500. This has been explained in conjunction with FIG. 4 and FIG. 5.

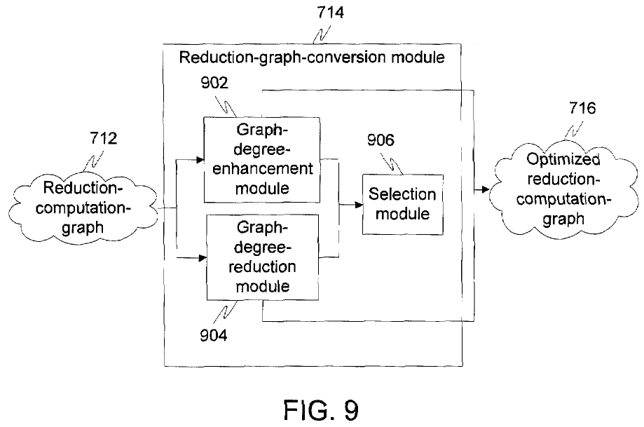

In an embodiment of the present invention, if computation graph 500 is a reduction-computation-graph 712, then a reduction-graph-conversion module 714 in system 700 converts reduction-computation-graph to an optimized reduction-computation-graph 716. In a reduction-computation-graph, each operator-switch-element for each computation level has preceding-computation-level operand elements. Each operator-switch-element is a parent node and the corresponding preceding-computation-level operand elements are child nodes. This has been explained in detail in conjunction with FIG. 2. Reduction-graph-conversion module 714 is further explained in detail in conjunction with FIG. 9.

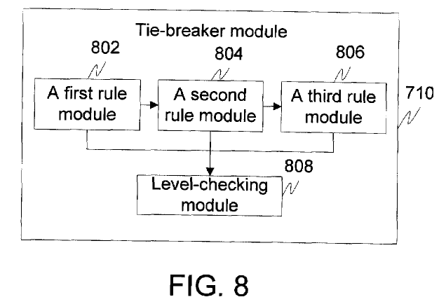

FIG. 8 is a block diagram showing modules of tie-breaker module 610 to determine an operator-switch-element for a computation level, in accordance with an embodiment of the present invention. Tie-breaker module 710 includes a first rule module 802, a second rule module 804, and a third rule module 806. First rule module 802 executes the first rule to determine one or more operator-switch-elements from a combination-tuple-set of switch-elements. The combination-tuple-set of switch-elements have least proximity link-cost-function. A tuple of a combination-tuple-set is a combination of operator-switch-elements. The operator-switch-element function as operand-switch-elements for a succeeding level in the computation graph. A proximity link-cost-function is an aggregate-link-cost-function of switch-elements in a tuple of the combination-tuple-set corresponding to a least common ancestor in the computation graph.

If the first rule determines an operator-switch-element for a current computation level, then first rule module 802 communicates with a level-checking module 808 to determine if the current computation level is the penultimate-computation-level. If level-checking module 808 determines that the current computation level is the penultimate level, mapper module 704 selects one or more last-computation-level operator-switch-elements. If a plurality of last-computation-level operator-switch-elements are determined, then third rule module 806 executes the third rule. The third rule determines a last-computation-level operator-switch-element with a least switch index. Each operator-switch-element is associated with a distinct switch index. The switch index of each operator-switch-element is an integer.

However, if the first rule determines a second plurality of operator-switch-elements, then second rule module 804 executes the second rule. The second rule determines one or more operator-switch-elements with least computation-table-entry records. A computation-table-entry stores one or more of inputs, format, datatype, computation function and outputs of an operator-switch-element. Thereafter, the second rule selects an operator-switch-element that has the least computation-table-entry record count. If the second rule determines an operator-switch-element for the current computation level, then second rule module 804 communicates with level-checking module 808 to determine if the current computation level is the penultimate-computation-level.

If the second rule determines a third plurality of operator-switch-elements, then third rule module 806 executes the third rule. The third rule determines an operator-switch-element with a least switch index. Each operator-switch-element is associated with a distinct switch index. The switch index of each operator-switch-element is an integer.

FIG. 9 is a block diagram showing modules of reduction-graph-conversion module 712, in accordance with an embodiment of the present invention. Reduction-graph-conversion module 712 includes a graph-degree-enhancement module 902 and a graph-degree-reduction module 904. Each of graph-degree-enhancement module 902 and graph-degree-reduction module 904 receives reduction-computation-graph 712 as an input. Thereafter, they communicate with a selection module 906. Selection module 906 determines if the degree of reduction-computation-graph 712 has to be increased or decreased. If degree of reduction-computation-graph 712 has to be increased, then graph-degree-enhancement module 902 increases degree of reduction-computation-graph 712 by adding children of child nodes to a target parent node to generate optimized reduction-computation-graph 716. The target parent node is parent of the child nodes. Thereafter, graph-degree-enhancement module 902 updates the reduction computation-table-entry of the target parent node in resource table 706 to process more operands in response to adding children of the child nodes. This has been explained in conjunction with FIG. 2.

However, if degree of reduction-computation-graph 712 has to be reduced, then graph-degree-reduction module 904 reduces a degree of reduction-computation-graph 712 by removing child nodes of a donor parent node to generate optimized reduction-computation-graph 716. The child nodes are attached to one of one or more of existing parent node and a new parent node. Thereafter, graph-degree-reduction module 904 updates the reduction computation-table-entry of the donor parent node in resource table 706 to process less operands in response to removing the child nodes. Further, graph-degree-reduction module 904 updates the reduction table entry of a recipient parent node to process increased number of operands. The recipient parent node receives the child nodes removed from the donor parent node. In an embodiment of the present invention, if a new parent node is added in the reduction computation graph, then graph-degree-reduction module 904 adds a reduction table entry to the new parent node to process operands for the child nodes of the donor parent node.

Various embodiment of the present invention provide methods and systems a method for placing computations in a communication network such that cost, power, and impact on latency in the communication network are reduced. The present invention uses communication behavior of compute nodes to place computation inside a network. This eliminates the need for placement of computation in every switch-element in the network. This invention allows placement of computation to meet resource availability constraints. Such resource availability constraints could be the number of switch-elements, state used inside each switch-element, latency bounds for a computation and their associated cost and power. Considering resources while placing computation appropriately inside a network allows computation and communication load on a SOE to be balanced across other switch-elements.

Further, in the present invention, communication graphs that have one-to-one, one-to-many, many-to-one and many-to-many patterns can be mapped to network topology graphs. Additionally, reduction computation graphs can be restructured to trade latency for reduced SOE state storage complexity and balanced compute/communication load. This allows compute nodes and switch-elements to be used together to realize highly complex computation in an efficient manner.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

1. A method of generating a computation graph corresponding to a communication graph and a network topology graph for a communication network interconnected using switch-elements, the method comprising:
determining at least one operator-switch-element for a computation level of the computation graph corresponding to at least one preceding-computation-level operand element using span vector representation of the network topology graph, wherein the network topology graph comprises a plurality of switch-elements and a plurality of compute nodes, wherein an operand element is at least one of a switch-element and a compute node, the at least one operator-switch-element is determined based on minimum link-cost-function of the at least one operator-switch-element corresponding to the at least one preceding-computation-level operand element, wherein an operator-switch-element receives operand values from the at least one preceding-computation-level operand element; and
selecting a last-computation-level operator-switch-element corresponding to a root-compute-node, wherein the last-computation-level operator-switch-element is selected based on a least aggregate-link-cost-function, an aggregate-link-cost-function corresponds to sum of minimum link-cost-function corresponding to one or more preceding-computation-level operand elements and a root-link-cost-function, the root-link-cost-function is a link-cost-function of a last-computation-level operator-switch-element corresponding to the root-compute-node, the root-compute-node receives an output of the computation graph corresponding to the last-computation-level operator-switch-element.

2. The method of claim 1, wherein the computation graph is generated for placing a plurality Switch Offload Engines (SOE) in the communication network, wherein each SOE comprises at least one computation-table-entry.

3. The method of claim 1, wherein link-cost-function of an operator-switch-element corresponding to at least one preceding-computation-level operand element is determined based on one of:
an average hop-count of each preceding-computation-level operand element relative to the operator-switch-element on the network topology graph;
sum of distance of each preceding-computation-level operand element relative to the operator-switch-element on the network topology graph;
maximum hop-count distance of the at least one preceding-computation-level operand element relative to the operator-switch-element on the network topology graph; and
weighted average of the hop-count distance of each preceding-computation-level operand relative to the operator-switch-element on the network topology graph.

4. The method of claim 1, wherein a tie-breaker algorithm comprising a plurality of rules is executed to determine an operator-switch-element for a computation level of the computation graph corresponding to at least one preceding-computation-level operand element, if a first plurality of operator-switch-elements for a computation level exists.

5. The method of claim 4, wherein the tie-breaker algorithm executes a first rule, the first rule determines at least one operator-switch-element from a combination-tuple-set of switch-elements, wherein proximity link-cost-function of the combination-tuple-set of switch-elements is least, a tuple of a combination-tuple-set is a combination of operator-switch-elements, wherein the operator-switch-element functions as operand-switch-elements for the succeeding level in the computation graph, a proximity link-cost-function is an aggregate-link-cost-function of switch-elements in a tuple of the combination-tuple-set corresponding to a least common ancestor in the computation graph.

6. The method of claim 4, wherein the tie-breaker algorithm executes a second rule, if the first rule determines a second plurality of operator-switch-elements, the second rule determines at least one operator-switch-element with least number of computation-table-entry record count, a computation-table-entry records at least one of inputs, format, datatype, computation function and outputs of an operator-switch-element.

7. The method of claim 4, wherein the tie-breaker algorithm executes a third rule, if the second rule determines a third plurality of operator-switch-elements, the third rule determines an operator-switch-element with a least switch index, wherein a switch index of each operator-switch-element is an integer, each operator-switch-element is associated with a distinct switch index.

8. The method of claim 4, wherein the second rule is executed before the first rule, if computation-table-entry record count corresponding to at least one operator-switch-element exceeds a predefined count threshold.

9. The method of claim 1, wherein the computation graph is a reduction computation-graph, each operator-switch-element for each computation level in the reduction-computation-graph has preceding-computation-level operand elements, wherein each operator-switch-element is a parent node and the corresponding preceding-computation-level operand elements are child nodes, each parent node performs a reduction operation on the corresponding child nodes

10. The method of claim 9, wherein a pass-through reduction table entry is made in a switch-element, a pass-through entry corresponds to passing operand values of each child node of a switch-element to a succeeding parent node.

11. The method of claim 9, wherein the degree of a reduction computation graph is increased by adding children of child nodes to a target parent node, the target parent node is parent of the child nodes, the reduction computation-table-entry of the target parent node is updated to process more operands in response to adding children of the child nodes.

12. The method of claim 9, wherein the degree of a reduction computation graph is reduced by removing child nodes of a donor parent node, the child nodes are attached to one of at least one existing parent node and a new parent node, the reduction computation-table-entry of the donor parent node is updated to process less operands in response to removing the child nodes, a reduction table entry of a recipient parent node is updated to process increased operands in response to removing the child nodes, wherein the recipient parent node receives the child nodes of the donor parent node, a reduction table entry of a new parent node is updated to process operands for the child nodes of the donor parent node.

13. A method of placing computation in a communication network using a plurality Switch Offload Engines (SOE) in a communication network interconnected using switch-elements, the method comprising:
providing a communication graph of the communication network;
extracting a network topology graph of the communication network, wherein the network topology graph is represented using span vectors; and
generating a computation graph corresponding to the communication graph and the network topology graph, the step of generating comprises:
determining at least one operator-switch-element for a computation level of the computation graph corresponding to at least one preceding-computation-level operand element using span vector representation of the network topology graph, wherein the network topology graph comprises a plurality of switch-elements and a plurality of compute nodes, wherein an operand element is at least one of a switch-element and a compute node, the at least one operator-switch-element is determined based on minimum link-cost-function of the at least one operator-switch-element corresponding to the at least one preceding-computation-level operand element, wherein an operator-switch-element receives operand values from the at least one preceding-computation-level operand element; and
selecting a last-computation-level operator-switch-element corresponding to a root-compute-node, wherein the last-computation-level operator-switch-element is selected based on a least aggregate-link-cost-function, an aggregate-link-cost-function corresponds to sum of minimum link-cost-function corresponding to one or more preceding-computation-level operand elements and a root-link-cost-function, the root-link-cost-function is a link-cost-function of a last-computation-level operator-switch-element corresponding to the root-compute-node, the root-compute-node receives an output of the computation graph corresponding to the last-computation-level operator-switch-element.

14. The method of claim 13, wherein the communication graph is provided by a programmer of the communication and computer network.

15. The method of claim 13, wherein the communication graph is provided by dynamic profiling programs.

16. A system for placing computation in a network by generating a computation graph corresponding to a communication graph and a network topology graph for a communication network by placing a plurality Switch Offload Engines (SOE) in the communication network, the system comprising:
a span-vector-list module, wherein the span-vector-list module represents a switch-element as a tuple in the network topology graph, a tuple comprises at least one of an element name, number of ports, one of a compute node and a switch-element on each port and a shortest hop-distance to each compute node and each switch-element communicating with the switch-element;
a mapper module, wherein the mapper module maps the communication graph to the network topology graph, wherein the mapper module is configured to:
determine at least one operator-switch-element for a computation level of the computation graph corresponding to at least one preceding-computation-level operand element using span vector representation of the network topology graph, wherein the network topology graph comprises a plurality of switch-elements and a plurality of compute nodes, wherein an operand element is at least one of a switch-element and a compute node, the at least one operator-switch-element is determined based on minimum link-cost-function of the at least one operator-switch-element corresponding to the at least one preceding-computation-level operand element, wherein an operator-switch-element receives operand values from the at least one preceding-computation-level operand element; and
selecting a last-computation-level operator-switch-element corresponding to a root-compute-node, wherein the last-computation-level operator-switch-element is selected based on a least aggregate-link-cost-function, an aggregate-link-cost-function corresponds to sum of minimum link-cost-function corresponding to one or more preceding-computation-level operand elements and a root-link-cost-function, the root-link-cost-function is a link-cost-function of a last-computation-level operator-switch-element corresponding to the root-compute-node, the root-compute-node receives an output of the computation graph corresponding to the last-computation-level operator-switch-element.

17. The system of claim 16, further comprising a resource table, wherein the resource table stores at least one of computation table entries and a table entry count for each switch-element.

18. The system of claim 16, wherein the mapper module comprises a tie-breaker module, the tie breaker module determines an operator-switch-element for a computation level, if a first plurality of operator-switch-elements are determined for the computation level with the same link-cost-function, the tie breaker module comprises:
a first rule module, wherein the first rule module executes a first rule, the first rule determines at least one operator-switch-element from a combination-tuple-set of switch-elements, wherein proximity link-cost-function of the combination-tuple-set of switch-elements is least, a tuple of a combination-tuple-set is a combination of operator-switch-elements, wherein the operator-switch-element functions as operand-switch-elements for the succeeding level in the computation graph, a proximity link-cost-function is an aggregate-link-cost-function of switch-elements in a tuple of the combination-tuple-set corresponding to a least common ancestor in the computation graph;
a second rule module, wherein the second rule module executes a second rule, if the first rule determines a second plurality of operator-switch-elements, the second rule determines at least one operator-switch-element with least number of computation-table-entry record count, a computation-table-entry records at least one of inputs, format, datatype, computation function and outputs of an operator-switch-element;
a third rule module, wherein the third rule module executes a third rule, if the second rule determines a third plurality of operator-switch-elements, the third rule determines an operator-switch-element with a least switch index, wherein a switch index of each operator-switch-element is an integer, each operator-switch-element is associated with a distinct switch index; and
a level-checking module, wherein the level-checking module determines if the computation level is the penultimate-computation level.

19. The system of claim 16, further comprising a link-cost-function module to determine link-cost-function of an operator-switch-element corresponding to at least one preceding-computation-level operand element based on one of:
an average hop-count of each preceding-computation-level operand element relative to the operator-switch-element on the network topology graph;
sum of hop-count distance of each preceding-computation-level operand element relative to the operator-switch-element on the network topology graph;
maximum hop-count distance of the at least one preceding-computation-level operand element relative to the operator-switch-element on the network topology graph; and
weighted average of the hop-count distance of each preceding-computation-level operand element relative to the operator-switch-element on the network topology graph.

20. The system of claim 16, further comprising a reduction-graph conversion module, the reduction-graph module comprising:
a graph-degree-enhancement module, wherein the graph-degree-enhancement module is configured to:
increase degree of a reduction computation graph by adding children of child nodes to a target parent node, the target parent node is parent of the child nodes; and
update the reduction computation-table-entry of the target parent node to process more operands in response to adding children of the child nodes.
a graph-degree-reduction module, wherein the graph-degree-reduction module is configured to:
reduce the degree of a reduction computation graph by removing child nodes of a donor parent node, the child nodes are re-attached to at least one of an existing parent node and a new parent node;
update the reduction computation-table-entry of the donor parent node to process less operands in response to removing the child nodes; update the reduction table entry of a recipient parent node to process increased number of operands, wherein the recipient parent node receives the child nodes; and
add a reduction table entry to the new parent node to process operands for the child nodes of the donor parent node.
